(19) United States
(12) Patent Application Publication
(10) Pub. No.: US 2011/0241611 A1
(43) Pub. Date: Oct. 6, 2011

(54) BATTERY CHARGER, BATTERY CHARGING CIRCUITS, AND SEMICONDUCTOR INTEGRATED CIRCUIT DEVICES

(75) Inventors: Takahiro Watanabe, Hamura (JP); Yoshitaka Abe, Ome (JP); Yoshihiro Hayashi, Akishima (JP); Makoto Tabuta, Hanno-shi (JP); Motonobu Fujii, Hanno-shi (JP)

(73) Assignees: HITACHI, LTD.; Shindengen Electric Manufacturing Co., Ltd.

(21) Appl. No.: 13/026,666

(22) Filed: Feb. 14, 2011

(30) Foreign Application Priority Data
Mar. 31, 2010 (JP) JP2010-81065

(51) Int. Cl. H02J 7/04

(52) U.S. Cl. 320/108

(57) ABSTRACT

Provided is a battery charging technique by which high efficiency of the battery charging can be always controlled no matter how the power consumption of the battery is changed. In a battery charger, a charging control circuit holds a charge/non-charge state of a battery during an arbitrary period of time in order to prevent the unbalance of phase voltages due to occurrence of transition between the charge/non-charge states during a short period of time and the reduction of the efficiency of the battery charging. Further, zero-crossing erroneous detection in a phase voltage of the output of a three-phase alternating-current generator due to noises is prevented.

### CROSS-REFERENCE TO RELATED APPLICATION

The present application claims priority from Japanese Patent Application No. 2010-081065 filed on Mar. 31, 2010, the content of which is hereby incorporated by reference into this application.

### TECHNICAL FIELD OF THE INVENTION

The present invention relates to a technique for battery charging. More particularly, the present invention relates to a technique effectively applied to a battery charger, a battery charging circuit, and a semiconductor integrated circuit device for battery charging control for a two-wheel vehicle.

### BACKGROUND

Conventionally, various battery chargers for two-wheel vehicles have been proposed. For example, in a battery charger disclosed in Japanese Patent Application Laid-Open Publication No. 2001-286074 (Patent Document 1), a method of reducing battery power loss caused by a leakage current from a charging control circuit and other circuit units in a state in which an output of a generator is not generated is disclosed.

### SUMMARY

Incidentally, in the above-described battery charger disclosed in Patent Document 1, to which an output of a permanent-magnet-type three-phase alternating-current generator (ACG) is inputted and which charges a battery by a DC voltage rectified by a three-phase full-wave rectifier, the battery charger includes: a Schottky-barrier-diode group connected to a positive side of the three-phase full-wave rectifier; and a FET group connected to a negative side thereof, an ACG starting detection circuit is connected to output of each phase of a generator, and a power switch connected between a positive side of the battery and a charging control circuit is controlled by the output of each phase.

The above-described configuration has characteristics such that, a gate terminal of each FET is to be at a positive bias (H level) in accordance with the timing (zero-cross) of synchronous rectification when an alternating-current input voltage is negative, the gate terminal of each FET is to be at a ground potential (L level) in accordance with the zero-cross when the alternating-current input voltage is positive, and the power switch is turned OFF when the ACG starting detection circuit determines that the output of the generator is not generated.

In this configuration, a battery charge state is achieved when a voltage of the battery is equal to or lower than a predetermined voltage, and a battery non-charge state is achieved when the voltage of the battery is equal to or higher than the predetermined voltage. However, since a period of the battery charge state/non-charge state is not controlled, sometimes, the three phases do not equally contribute to the battery charge, or the three phases do not equally become the battery non-charge state. For example, when power consumption of the battery is relatively low, if the battery voltage is caused to be equal to or higher than the predetermined voltage by charge in a positive voltage of any one or two phases of U, V, and W phases, the battery is not charged in a positive voltage of a subsequent phase. Conversely, when the power consumption of the battery is relatively high, the charging restarts from a phase subsequent to a non-charging phase. In this manner, when the transition between the charge/non-charge states occurs during a short period of time, each phase voltage of the output of the generator is unbalanced sometimes. Accordingly, after the transition between the charge/non-charge states, it is difficult to cause the zero crossing of the phase voltage, and efficiency of the battery charging by the synchronous rectification is reduced.

Therefore, a typical preferred aim of the present invention is to provide a battery charging technique by which the high efficiency of the battery charging can be always controlled no matter how the power consumption of the battery is changed.

The above and other preferred aims and novel characteristics of the present invention will be apparent from the description of the present specification and the accompanying drawings.

The typical ones of the inventions disclosed in the present application will be briefly described as follows.

That is, the typical one is summarized that, in a battery charging technique for a battery charger or others, a charging control circuit holds a battery charge/non-charge state during an arbitrary period of time in order to prevent the unbalance of the phase voltage due to occurrence of the transition between charge/non-charge states during a short period of time and the reduction of the efficiency of the battery charging.

The effect obtained by typical aspects of the present invention will be briefly described below.

That is, the effect obtained by the typical aspects is capable of providing a battery charging technique by which efficiency of the battery charging can be always highly controlled no matter how the power consumption of the battery is changed.

### BRIEF DESCRIPTIONS OF THE DRAWINGS

FIG. 1 is a diagram illustrating a configuration example of a battery charger according to an embodiment of the present invention;

FIG. 2 is a diagram illustrating voltage waveform examples in a configuration of a battery charger according to a conventional technique;

FIG. 3 is a diagram illustrating voltage waveform examples in a configuration of a battery charger according to the embodiment of the present invention;

FIG. 4 is a diagram illustrating a configuration example of a charging control circuit in the battery charger according to the embodiment of the present invention;

FIG. 5 is a diagram illustrating a configuration example of a charge/non-charge holding circuit in the battery charger according to the embodiment of the present invention; and

FIG. 6 is a diagram illustrating a configuration example of a zero-crossing detection circuit in the battery charger according to the embodiment of the present invention.

### DETAILED DESCRIPTION OF THE EXEMPLARY EMBODIMENTS

Hereinafter, embodiments of the present invention will be described in detail with reference to the accompanying drawings.

Note that components having the same function are denoted by the same reference symbols throughout the drawings for describing the embodiment, and the repetitive description thereof will be omitted.

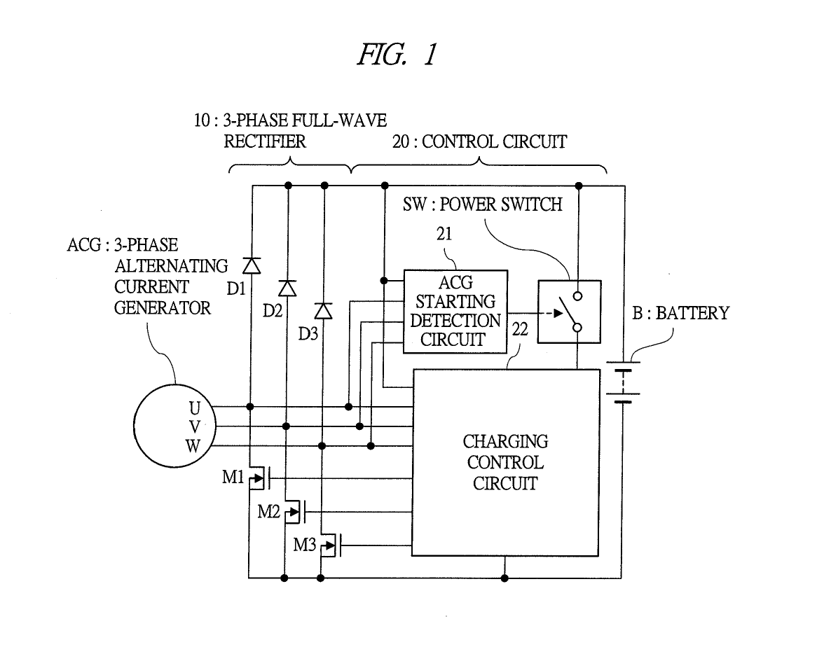

FIG. 1 is a diagram illustrating a configuration example of a battery charger according to an embodiment of the present invention.

The battery charger according to the present embodiment is a battery charger to which output of a permanent-magnet-type three-phase alternating-current generator ACG is inputted and which charges a battery B by a DC voltage rectified by a three-phase full-wave rectifier, and is composed of: a three-phase full-wave rectifier 10; and a control circuit 20.

The three-phase full-wave rectifier 10 is a circuit to which the output of the three-phase alternating-current generator ACG is inputted and which rectifies the input to a DC voltage. The three-phase full-wave rectifier 10 is composed of: a rectifying element group composed of rectifying elements D1, D2, and D3 of respective phases, which is connected to a positive side of the three-phase full-wave rectifier; and a switching element group composed of switching elements M1, M2, and M3 of respective phases, which is connected to a negative side thereof. The rectifying element group may be, for example, a Schottky-barrier-diode group composed of Schottky barrier diodes in which D1, D2, and D3 are examples of respective rectifying elements. However, the present invention is not limited to this, and the rectifying element group may be a rectifying element group in which D1, D2, and D3 are composed of other diodes. Also, the switching element group may be, for example, a FET group composed of FETs in which M1, M2, and M3 are examples of respective switching elements. However, the present invention is not limited to this, and the switching element group may be, for example, a bipolar transistor group in which M1, M2, and M3 are composed of bipolar transistors.

The control circuit 20 is a circuit which controls the switching element group composed of the switching elements M1, M2, and M3 when the battery B is charged by the DC voltage rectified by the three-phase full-wave rectifier 10. The control circuit 20 is composed of: a power switch SW which connects the DC voltage or the power of the battery B to the control circuit 20; an ACG starting detection circuit 21 which controls ON/OFF of the power switch SW in accordance with presence/absence of the output power of the three-phase alternating-current generator ACG or magnitude relation between the voltage of the battery B and a predetermined voltage; and a charging control circuit 22 which controls gates of the switching element group. The charging control circuit 22 is configured so as to hold charge/non-charge period of the battery B during an arbitrary period of time.

The ACG starting detection circuit 21 turns OFF the power switch SW so that the power of the battery B is not consumed by the leakage current of the charging control circuit 22 when the three-phase alternating-current generator ACG is stopped, and turns ON the power switch SW so as to supply power to the charging control circuit 22 when the three-phase alternating-current generator ACG is operated. The ACG starting detection circuit 21 and the power switch SW are not relevant to the present invention, and therefore, detailed descriptions of their operations are omitted.

The charging control circuit 22 detects the U-, V-, and W-phase voltages of the outputs of the three-phase alternating-current generator ACG, turns ON/OFF the switching elements M1, M2, and M3, synchronously rectifies the alternating-current voltages of the outputs of the three-phase alternating-current generator ACG to charge the battery B, and controls the voltage of the battery B to be a predetermined voltage. Moreover, the charging control circuit 22 holds the charge/non-charge state during an arbitrary period of time so that the charge/non-charge states are not generated within a short period of time, and controls so that reduction in the power generating efficiency due to the unbalanced phase voltages is not generated.

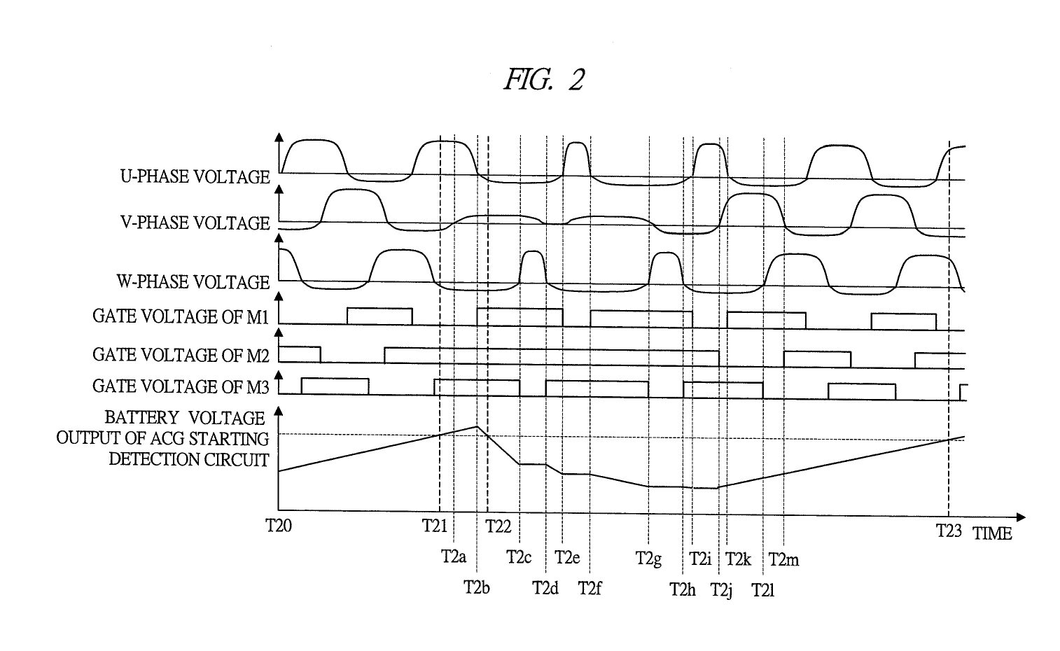

FIG. 2 is a diagram illustrating voltage waveform examples in a configuration of a battery charger according to a conventional technique. More specifically, FIG. 2 illustrates voltage waveform examples in a case in which the charge state is continued during a long period of time and the non-charge state is continued during a short period of time.

Periods of time from T20 to T21 and from T22 to T23 are in the charge state in which the battery voltage is lower than the predetermined value, and periods of time from T21 to T22 and after T23 are in the non-charge state in which the battery voltage is higher than the predetermined value. In the charge state, the gate voltages of the switching elements M1, M2, and M3 are changed in accordance with zero-crossing of the U-, V-, and W-phase voltages for the charging. In the non-charge state, even when the zero crossing is caused in the U-, V-, and W-phase voltages from a negative side to a positive side, the gate voltages of the switching elements M1, M2, and M3 are held at the H level.

Here, as an example, there are the waveforms of unbalanced phase voltages generated in a case in which the non-charge state from the time T21 to T22 is short and a positive pulse of the V phase is in the non-charge state only once. The first zero-crossing from the negative side to the positive side after the non-charged state is achieved occurs in the V phase at time T2a. However, because of the non-charge state, the gate voltage of the switching element M2 is held at the H level, and therefore, the battery B is not charged. At time T2b, the zero-crossing from the positive side to the negative side occurs in the U phase, and the gate voltage of the switching element M1 is changed to the H level, and therefore, the battery charging period is finished. No charge is supplied to the battery from the time T2b, and therefore, the voltage of the battery is dropping in accordance with the power consumption of equipment, and the voltage of the battery becomes lower than the predetermined voltage at time T22, and therefore, the charge state is achieved again.

Next, at time T2c, the zero-crossing from the negative side to the positive side occurs in the W-phase, and therefore, the gate voltage of the switching element M3 is changed to the L level. However, since the positive pulse of the V-phase has just been in the non charge state once, the voltages inside the three-phase alternating-current generator ACG are unbalanced, and therefore, the charging is carried out only during the short period of time (from T2c to T2d). Next, the zero-crossing from the negative side to the positive side occurs in the U phase at time T2e, and the gate voltage of the switching element M1 is changed to the L level. However, similarly, the charging is carried out only during a short period of time (from T2e to T2f). During this period, the zero-crossing does not occur in the V phase from the time T2d to T2e, and therefore, the charging from the V phase is not carried out. And then, slight short charging from the W phase is carried out from time T2g to T2h and that from the U phase is carried out from time T2i to T2k, and, after the charging from the V phase at time T2j, the voltages of the three-phase alternating-current generator ACG is balanced, and the charging from each phase is carried out during a normal period of time.

As described above, when the non-charge period is short, the voltages of the three-phase alternating-current generator ACG are unbalanced, and therefore, the efficiency of the battery charging may be reduced. Moreover, although not illustrated in the drawing, conversely to this, even when the charging period is short, the voltages of the three-phase alternating-current generator ACG are unbalanced, and therefore, the efficiency of the battery charging may be reduced. However, the unbalanced degree of the voltages of the three-phase alternating-current generator ACG described here depends on the characteristics of the three-phase alternating-current generator ACG, and therefore, the unbalanced degree is not always as illustrated in the drawing.

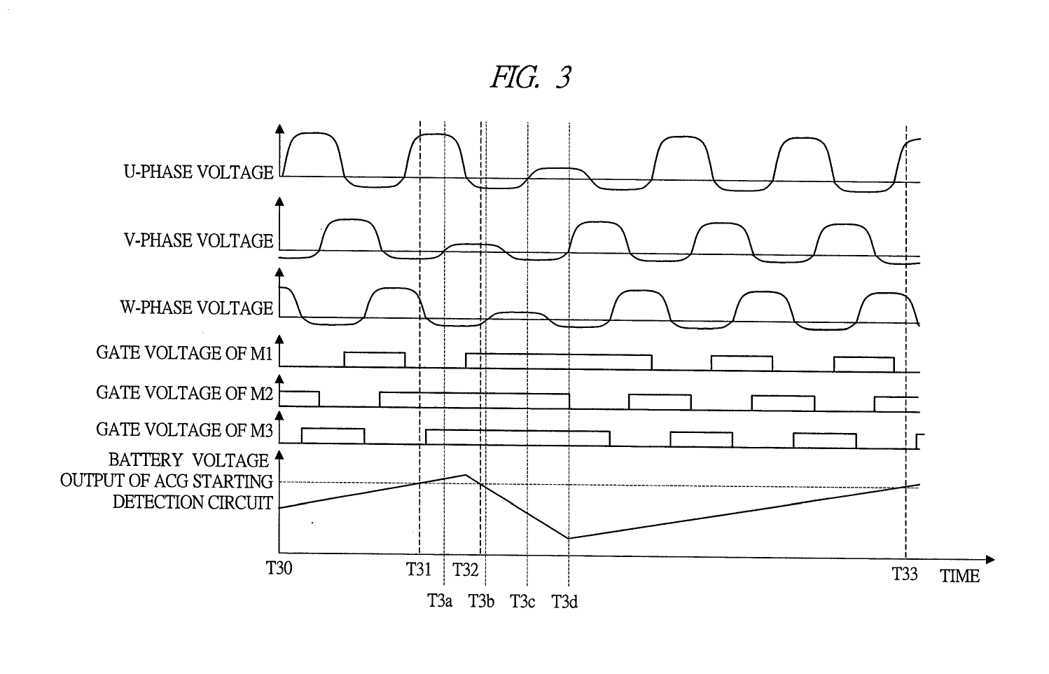

FIG. 3 is a diagram illustrating voltage waveform examples in a configuration of a battery charger according to the present embodiment. More specifically, FIG. 3 illustrates voltage waveform examples in a case in which the non-charge state is achieved during a short period of time.

Periods of time from T30 to T31 and from T32 to T33 are in the charge state in which the voltage of the battery is equal to or lower than the predetermined value, and periods of time from T31 to T32 and after T33 are in the non-charge state in which the voltage of the battery is equal to or higher than the predetermined value. Moreover, it is controlled to hold a phase voltage pulse to be in the non-charge state for at least one cycle of each of U, V, and W phases. From a period of time when the zero-crossing from the negative side to the positive side occurs in the V phase at time T3a, the gate voltages of the switching elements M1, M2, and M3 are held at the H level even when the zero-crossing from the negative side to the positive side occurs in the W and U phases at time T3b and T3c, respectively, and therefore, the battery B is not charged. As described above, when the outputs of the three-phase alternating-current generator ACG are not charged during a certain period of time, the unbalance of the voltages of the three-phase alternating-current generator ACG is solved, and therefore, the efficiency of the battery charging in the charging operation after the time T3d is not reduced. Although not illustrated in the drawing, conversely to this, even when the charging period is short, the reduction in the efficiency of the battery charging can be prevented by providing the charging period during a certain period of time or longer. Moreover, the period of time for one cycle of each of the U, V, and W phases is set as the state holding period here. However, the state holding period can be changed depending on, for example, the characteristics of the three-phase alternating-current generator ACG.

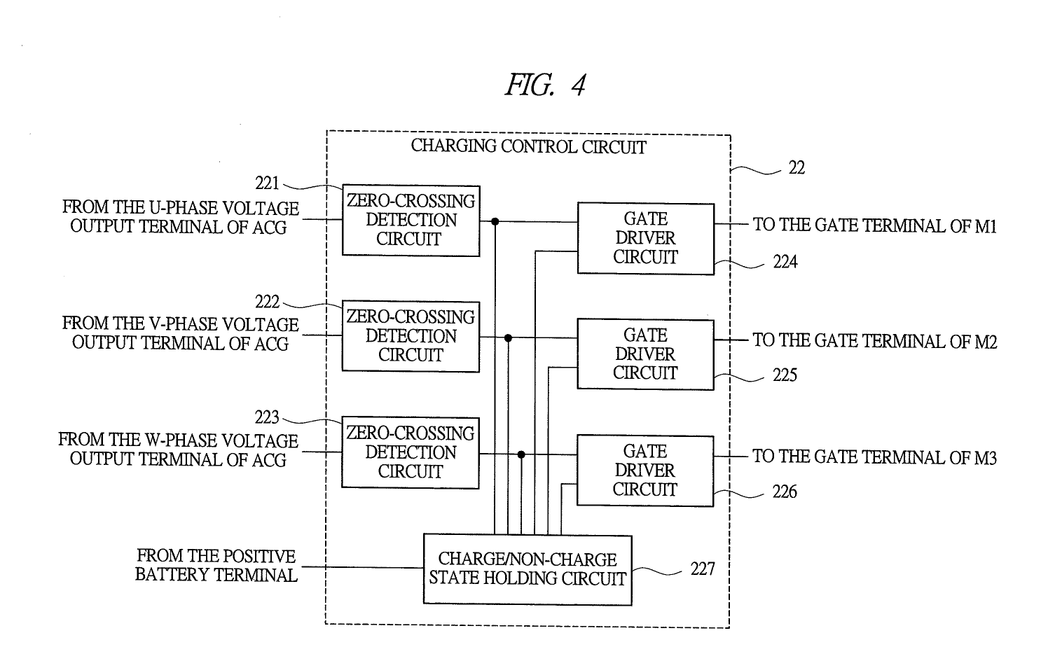

The configuration of the charging control circuit 22 according to the present embodiment is variously considered, and can be, for example, a configuration illustrated in FIG. 4. FIG. 4 is a diagram illustrating a configuration example of the charging control circuit 22.

The charging control circuit 22 is composed of: zero-crossing detection circuits 221, 222, and 223; gate driver circuits 224, 225, and 226; and a charge/non-charge state holding circuit 227. To the zero-crossing detection circuits 221, 222, and 223, the phase voltages of the outputs of the three-phase alternating-current generator ACG are inputted, and the zero-crossing detection circuits output whether the zero-crossing from the positive side to the negative side or from the negative side to the positive side has occurred or not. To the charge/non-charge state holding circuit 227, the voltage of the battery B and the outputs of the zero-crossing detection circuits 221, 222, and 223 are inputted, and the charge/non-charge state holding circuit holds the charge state during a predetermined period of time after the voltage of the battery becomes equal to or lower than the predetermined voltage or holds the non-charge state during a predetermined period of time after the voltage of the battery becomes equal to or higher than a predetermined voltage, and outputs the holding state. To the gate driver circuits 224, 225, and 226, the outputs of the zero-crossing detection circuits 221, 222, and 223 and the charge/non-charge holding state circuit 227 are inputted, and the gate driver circuits drives gates by outputting the H/L level in accordance with the zero-crossing detection in each phase voltage if the output of the charge/non-charge state holding circuit 227 is in the charge state, or continuously outputting the H level if it is in the non-charge state even when the zero crossing from the negative side to the positive side occurs in each phase voltage.

In this configuration example of the charging control circuit 22, cost can be reduced by reducing the number of units and reducing the mounting area thereof by integrating all or a part of the configuration example. Circuits of the units which can be integrated are formed on a semiconductor chip, and are produced as a semiconductor integrated circuit device. In the produced semiconductor integrated circuit device, in addition to the charging control circuit 22, all or a part of the ACG starting detection circuit 21 and the power switch SW illustrated in FIG. 1 are also integrated together often. Also, a form in which the integrate-circuited semiconductor integrated circuit device and other units are mounted on a wiring board becomes the battery charging circuit which configures the battery charger.

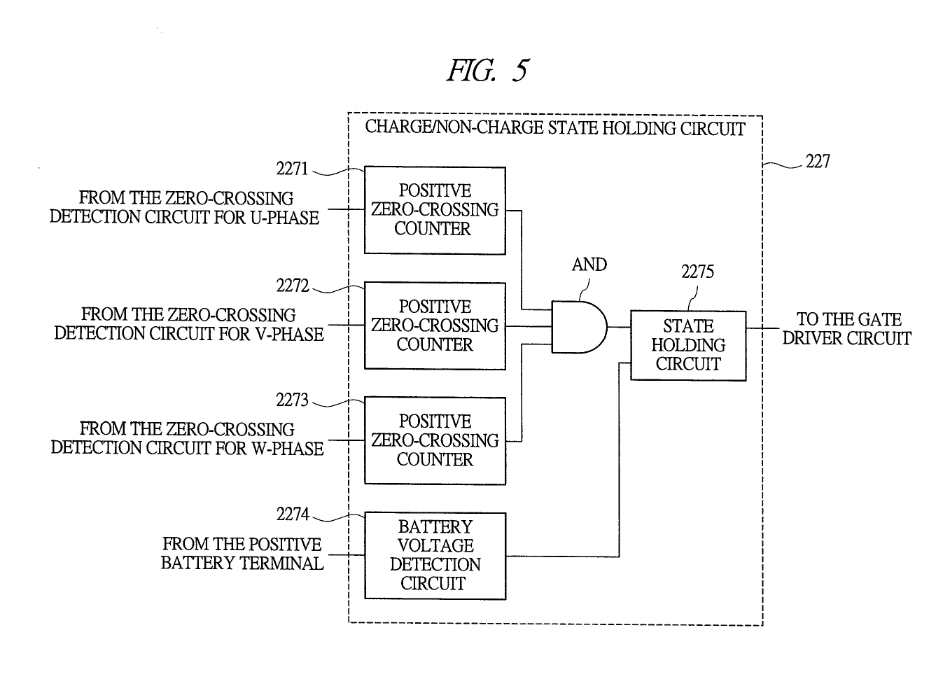

Some methods of achieving the charge/non-charge state holding circuit 227 can be considered, and the charge/non-charge state holding circuit 227 can be as, for example, a configuration example illustrated in FIG. 5. FIG. 5 is a diagram illustrating the configuration example of the charge/non-charge state holding circuit 227.

Here, a configuration in which the charge/non-charge state is held during one cycle of each phase voltage of the U, V, and W phases is illustrated. The present circuit is composed of: negative-to-positive (positive) zero-crossing counters 2271, 2272, and 2273; a battery voltage detection circuit 2274; an AND gate circuit AND; and a state holding circuit 2275. To the negative-to-positive zero-crossing counters 2271, 2272, and 2273, outputs of the zero-crossing detection circuits 221, 222, and 223 are inputted, and the negative-to-positive zero-crossing counters increment a count in accordance with occurrence of the zero-crossing from the negative side to the positive side, output the H level when the count is 1 or higher, and reset the count in accordance with the change of the output of the AND gate circuit AND to the H level. The battery voltage detection circuit 2274 outputs the charge state when the voltage of the battery is equal to or lower than the predetermined value, or outputs the non-charge state when the voltage of the battery is equal to or higher than the predetermined value. To the state holding circuit 2275, the logical multiplication (AND) among the outputs of the negative-to-positive zero-crossing counters 2271, 2272, and 2273 and the output of the battery voltage detection circuit 2274 are inputted, and the state holding circuit holds to output an output value of the battery voltage detection circuit 2274 generated when the logical multiplication among the outputs of the negative-to-positive zero-crossing counters 2271, 2272, and 2273 is changed from the L level to the H level. In this example, since the same value is outputted to the gate driver circuits 224, 225, and 226, the charge/non-charge state holding circuit 227 has one output terminal. However, in accordance with the state holding period, the output may be divided for each of the gate driver circuits 224, 225, and 226. Moreover, the charge/non-charge state may be held during a period except for the one cycle in accordance with the characteristics of the three-phase alternating-current generator ACG or others, or the state holding periods for the charge state and the non-charge state may be different from each other. In that case, it is required to replace the units of the above-described negative-to-positive zero-crossing counters and AND gate circuit with a counter and a control logic circuit suitable for holding a desired period.

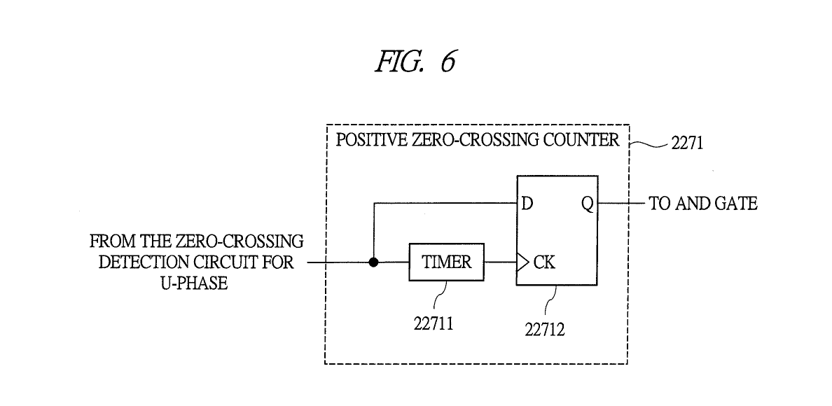

In the negative-to-positive zero-crossing counters 2271, 2272, and 2273 illustrated in FIG. 5, due to superimposing of noises from the three-phase alternating-current generator ACG or others with the phase voltages, if there are no noises, one count of the zero crossing from the positive side to the negative side is erroneously counted as plural counts of the zero crossing from the positive side to the negative side sometimes. Accordingly, the charge/non-charge holding circuit 227 cannot correctly recognize the predetermined period, and, as a result, the efficiency of the battery charging may be reduced. A circuit for preventing this erroneous counting may be inserted into the negative-to-positive zero-crossing counters 2271, 2272, and 2273. Some methods of preventing the erroneous counting can be considered, and an example of achieving the method is illustrated in FIG. 6. FIG. 6 is a diagram illustrating a configuration example of a negative-to-positive zero-crossing counter 2271. The same goes for the other negative-to-positive zero-crossing counters 2272 and 2273.

The present configuration example is composed of: a timer 22711; and a flip-flop circuit 22712. To the configuration, the negative-to-positive zero-crossing detection from the zero-crossing detection circuit 221 is inputted, and the timer 22711 and the flip-flop circuit 22712 are connected to each other. When the erroneous detection of the plural counts occurs due to the noises, the output of the negative-to-positive zero-crossing counter 2271 is set to be the output of the zero-crossing detection circuit 221 obtained after passing the time defined by the timer 22711 from a first detection. Note that the time defined by the timer 22711 is the time optimized in accordance with the noise characteristics of the three-phase alternating-current generator ACG, and the timer 22711 may be a one-shot timer or a retriggerable timer.

According to the battery charger, the battery charging circuit, and the semiconductor integrated circuit device of the present embodiment described above, the charging control circuit 22 holds the charge/non-charge state of the battery B during an arbitrary period of time in order to prevent the unbalance of the phase voltages due to occurrence of the transition between the charge/non-charge states during a short period of time and the reduction of the efficiency of the battery charging, so that high efficiency of the battery charging can be always controlled no matter how the power consumption of the battery is changed.

In the foregoing, the invention made by the inventors of the present invention has been concretely described based on the embodiments. However, it is needless to say that the present invention is not limited to the foregoing embodiments and various modifications and alterations can be made within the scope of the present invention.

What is claimed is:

1. A battery charger to which an output of a permanent-magnet-type generator is inputted and which charges a battery by a DC voltage rectified by a full-wave rectifier, wherein
the full-wave rectifier includes: a rectifying element group connected to a positive side of the full-wave rectifier; and a switching element group connected to a negative side thereof,
the battery charger includes a control circuit for controlling the switching element group,
the control circuit includes a charging control circuit for controlling gates of the switching element group, and
the charging control circuit is configured so as to hold a charge/non-charge state of the battery during an arbitrary period of time.

2. The battery charger according to claim 1, wherein
the charging control circuit is configured so as to prevent zero-crossing erroneous detection in a phase voltage of the output of the generator due to noises.

3. The battery charger according to claim 1, wherein
the charging control circuit includes:
a zero-crossing detection circuit for detecting zero crossing from a positive side to a negative side or from the negative side to the positive side in a phase voltage of the output of the generator;
a charge/non-charge holding circuit for holding the charge state during a predetermined period of time after a voltage of the battery becomes equal to or lower than a predetermined voltage or holding the non-charge state during a predetermined period of time after the voltage of the battery becomes equal to or higher than the predetermined voltage; and
a gate driver circuit for driving gates by outputting an H level or an L level in accordance with the zero-crossing detection in each phase voltage of the zero-crossing detection circuit if an output of the charge/non-charge holding circuit is in the charge state, or continuously outputting an H level if the output of the charge/non-charge holding circuit is in the non-charge state even when the zero crossing from the negative side to the positive side occurs in the phase voltage.

4. A battery charging circuit comprising:
a full-wave rectifier, which includes a rectifying element group connected to a positive side of the full-wave rectifier and a switching element group connected to a negative side thereof, to which an output of a permanent-magnet-type generator is inputted, and which rectifies the input; and
a control circuit for controlling the switching element group when a battery is charged by a DC voltage rectified by the full-wave rectifier, wherein
the control circuit includes a charging control circuit for controlling gates of the switching element group, and
the charging control circuit is configured so as to hold a charge/non-charge state of the battery during an arbitrary period of time.

5. The battery charging circuit according to claim 4, wherein
the charging control circuit is configured so as to prevent zero-crossing erroneous detection in a phase voltage of the output of the generator due to noises.

6. The battery charging circuit according to claim 4, wherein
the charging control circuit includes:
a zero-crossing detection circuit for detecting zero crossing from a positive side to a negative side or from the negative side to the positive side in a phase voltage of the output of the generator;
a charge/non-charge holding circuit for holding the charge state during a predetermined period of time after a voltage of the battery becomes equal to or lower than a predetermined voltage or holding the non-charge state during a predetermined period of time after the voltage of the battery becomes equal to or higher than the predetermined voltage; and
a gate driver circuit for driving gates by outputting an H level or an L level in accordance with the zero-crossing detection in each phase voltage of the zero-crossing detection circuit if an output of the charge/non-charge holding circuit is in the charge state, or continuously outputting an H level if the output of the charge/non-charge holding circuit is in the non-charge state even when the zero crossing from the negative side to the positive side occurs in the phase voltage.

7. A semiconductor integrated circuit device comprising a control circuit for controlling a switching element group of a full-wave rectifier when a battery is charged by a DC voltage rectified by the full-wave rectifier to which an output of a permanent-magnet-type generator is inputted, wherein
the control circuit includes a charging control circuit for controlling gates of the switching element group, and
the charging control circuit is configured so as to hold a charge/non-charge state of the battery during an arbitrary period of time.

8. The semiconductor integrated circuit device according to claim 7, wherein
the charging control circuit is configured so as to prevent zero-crossing erroneous detection in a phase voltage of the output of the generator due to noises.

9. The semiconductor integrated circuit device according to claim 7, wherein
the charging control circuit includes:
a zero-crossing detection circuit for detecting zero crossing from a positive side to a negative side or from the negative side to the positive side in a phase voltage of the output of the generator;
a charge/non-charge holding circuit for holding the charge state during a predetermined period of time after a voltage of the battery becomes equal to or lower than a predetermined voltage or holding the non-charge state during a predetermined period of time after the voltage of the battery becomes equal to or higher than the predetermined voltage; and
a gate driver circuit for driving gates by outputting an H level or an L level in accordance with the zero-crossing detection in each phase voltage of the zero-crossing detection circuit if an output of the charge/non-charge holding circuit is in the charge state, or continuously outputting an H level if the output of the charge/non-charge holding circuit is in the non-charge state even when the zero crossing from the negative side to the positive side occurs in the phase voltage.
